(19) United States
(12) Patent Application Publication
(10) Pub. No.: US 2011/0122242 A1
(43) Pub. Date: May 26, 2011

(54) DIGITAL MICROSCOPY EQUIPMENT WITH IMAGE ACQUISITION, IMAGE ANALYSIS AND NETWORK COMMUNICATION

(75) Inventors: Hrushikesh Tukaram Garud, Parbhani (IN); Debdoot Sheet, Kharagpur (IN); Jyotirmoy Chatterjee, Kharagpur (IN); Manjunatha Mahadevappa, Kharagpur (IN); Ajoy Kumar Ray, Kharagpur (IN)

(73) Assignee: Texas Instruments Incorporated, Dallas, TX (US)

(21) Appl. No.: 12/979,398

(22) Filed: Dec. 28, 2010

Related U.S. Application Data
(63) Continuation-in-part of application No. 12/605,400, filed on Oct. 26, 2009.
Application No. 12/605,400 is a continuation-in-part of application No. 12/605,394, filed on Oct. 26, 2009.

(51) Int. Cl. H04N 7/18; G06K 9/00

(52) U.S. Cl. 348/79; 382/133; 348/E07.085

(57) ABSTRACT

A digital microscope comprises a housing with an image acquisition, an image processing, and a network communication (APC) module. The APC module can further comprise an image capture unit, coupled to an image sensor with a view to a subject on a slide, the image capture unit receiving an image of the subject. The APC module also comprises an image processing unit, coupled to the image capture unit, the image processing unit enhancing the image with classifications. Also, a network interface of the APC module, coupled to the image processing unit and to a network, the network interface sending the enhanced image across to the network and to receive control commands, the control commands associated with the view of the subject.

### CROSS-REFERENCE TO RELATED APPLICATIONS

The present application claims priority under 35 USC 120 as a continuation-in-part of co-pending U.S. application Ser. No. 12/605,400, filed on Oct. 26, 2009, by Mitra et al., and entitled METHOD AND SYSTEM FOR DETECTION OF ORAL SUB-MUCOUS FIBROSIS USING MICROSCOPIG IMAGE ANALYSIS OR ORAL BIOPSY SAMPLES, and as a continuation-in-part of co-pending U.S. application Ser. No. 12/605,394, filed on Oct. 26, 2009, by Garud et al. and entitled METHOD AND SYSTEM FOR ANALYZING BREAST CARCINOMA USING MICROSCOPIC IMAGE ANALYSIS OF FINE NEEDLE ASPIRATES the entire contents of being hereby incorporated by reference.

### BACKGROUND

1. Technical Field

Embodiments of the invention relate generally to the field of digital microscopes, and more specifically, to a digital microscope with integrated image acquisition, processing and communication.

2. Prior Art

When a patient has physical symptoms that require analysis beyond the capability or equipment available to a doctor, the doctor can collect a sample to be analyzed by a pathologist. For example, a doctor can shave a sample off of a skin growth to have a biopsy performed. The pathologist examines the sample in further detail, such as under a microscope, before sending a report and findings to the initiating doctor. The turnaround time for lab results can be from a couple of days to a couple of weeks. Valuable time can be lost as the initiating doctor and patient await results from the laboratory. The physical sample has to be mailed or couriered from the doctor's office to the pathology center where the sample is prepared for analysis.

At this point, the pathologist has to physically visit the pathology center to analyze the sample in person. Then, images of the sample are captured by a camera that is positioned proximate to the microscope. The images are transferred from the camera to a personal computer for comparison against samples of normal conditions by a separate software application running on a personal computer. Then the pathologist prepares a report and findings to send back to the initiating doctor. Problematically, the various time delays can slow down diagnosis and subsequent treatment of an ill patient.

Some pathology centers provide remote access to pathology samples by allowing an offsite pathologist to review samples. For example, a video feed through a video conference system can be provided from a pathology center to a pathologist for review. The pathologist can give verbal commands for viewing different parts of a slide containing the sample. Other pathology centers have leveraged the Internet to cut down the time delays. More specifically, a personal computer can be connected to a digital microscope to add additional functionality such as network connectivity. However, these solutions are not adequate. Particularly, each of these devices operates independently and requires manual configuration and complex knowledge of computer software to transfer data between the components. Each of the devices comes with different power sources, separate controllers, and occupies independent floor space. Consequentially, the state of the art techniques can be expensive and complex.

Furthermore, the images of a sample as seen through a microscope can be of little use to a pathologist in their raw form. The images are often cluttered with other irrelevant noise that can be distracting or prevent a clear view of relevant subject matter. As a result, the pathologist would also need to acquire a data file for the image for processing by a separate application. Accordingly, the image data is transferred into the image processing application to identify certain markers known to those of the medical field. The resulting image is then transferred from the image processing application to a separate application to create a report.

In light of the foregoing discussion, there is a need for an efficient method and system for image acquisition, image processing and network communications integrated within a digital microscope.

### SUMMARY

Embodiments of the present disclosure described herein provide a method, a computer program product and system for image acquisition, image processing, and network communications. The embodiments can be used in a variety of environments such as a telepathology, telemicroscopy and telemedicine environments.

In one embodiment, a digital microscope comprises a housing with an image acquisition, an image processing, and a network communication (APC) module. The digital microscope can also include an image sensor, or camera, and a microscopic lens. The APC module can further comprise an image capture unit, coupled to an image sensor with a view to a subject on a slide, the image capture unit receiving an image of the subject. The APC module also comprises an image processing unit, coupled to the image capture unit, the image processing unit enhancing the image with classifications. Also, a network interface of the APC module is coupled to the image processing unit and to a network to send the enhanced image across to the network and to receive control commands, the control commands associated with the view of the subject. For example, remotely located pathologist or other user can control the digital microscope by changing illumination, z-positioning or magnification, aperture diameter, and stage positioning.

In another embodiment, the image processing unit of the APC module can further include a digital signal processing unit. The image processing unit can generate an abnormality marked image by comparing the subject on the image to a reference subject on a reference image. A motor driver can provide synchronous telepathology in cooperating with the network interface, responsive to command controls received by the network interface (e.g., from the pathologist). The image capture unit can also receive video. The image processing unit can be embedded on a single processor, or even a single substrate. In one embodiment, the image processing unit includes a physical port to connect, for example, wired Ethernet.

In yet another embodiment, a method is performed within a digital microscope devices that comprises a housing having an image capture unit, an image processing unit, and a network interface. The method comprises receiving an image of a subject. The image is enhanced with classifications. The enhanced images can be sent across to the network. Control commands are received from the network, the control commands associated with the view of the subject.

Advantageously, a turnkey solution is provided for telepathology with a single digital microscope device. The digital microscope uses less space, costs less, and includes integrated functionality without the need for interfacing with a personal computer.

### BRIEF DESCRIPTION OF THE DRAWINGS

In the following drawings like reference numbers are used to refer to like elements. Although the following figures depict various examples of the invention, the invention is not limited to the examples depicted in the figures.

FIG. 1 is a block diagram illustrating a telepathology system according to one embodiment.

FIG. 2 is a schematic illustrating a digital microscope with integrated image acquisition, image processing and network communication (APC) module according to one embodiment.

FIG. 3 is a schematic illustrating an alternative embodiment of a digital microscope with an integrated APC module according to another embodiment.

FIG. 4 is a schematic diagram illustrating details of an APC module according to one embodiment.

FIG. 5 is a flow diagram illustrating a method for image acquisition, image processing and network communication according to an embodiment.

### DETAILED DESCRIPTION OF THE EMBODIMENTS

Embodiments of the present disclosure described herein provide a method, a computer program product and system for image acquisition, image processing, and network communications.

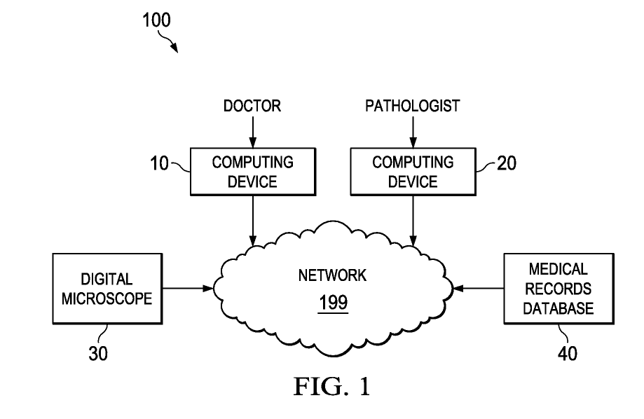

FIG. 1 is a block diagram illustrating a telepathology system 100 according to one embodiment. The telepathology system includes a doctor using a computing device 10 and a pathologist using a computing device 20 to access a digital microscope 30 and a medical records database 40 over a network 199 (e.g., the Internet, a LAN or local access network, a WAN or a wide access network, a SAN or a storage area network, connected wired or wirelessly, and any combination of network types). In one example, the computing devices 10, 20 connect to the network 199 over an Ethernet connection operating in accordance with the network protocol IEEE 802.11. The system 100 of the present embodiment is discussed with reference to a telepathology environment for the purposes of illustration only. Given the disclosure herein, additional applications to a telemicroscopy or telemedicine environments and other type of environments will be apparent.

The computing devices 10, 20 can be a personal computer, a laptop computer, a tablet device, a mobile telephone, a terminal, or any type of processor-based device with network capability. The computing devices 10, 20 can further include components not detailed FIG. 1, such as a processor (e.g., a CPU or central processing unit such as an x86 platform processor, a mobile processor such as an ARM or advanced RISC machine platform processor), a memory (volatile and non-volatile types), a display device and an input device. The computing devices 10, 20 can run an operating system from a main memory such as Windows by Microsoft Corp. The computing devices 10, 20 can run an application-layer software client or daemon that interfaces with the digital microscope 30 and/or the medical records database 40. The application-layer software can be installed from a CD or downloaded over a network. In another embodiment, the computing devices 10, 20 can run a general application such as a web browser that provide interfacing capabilities.

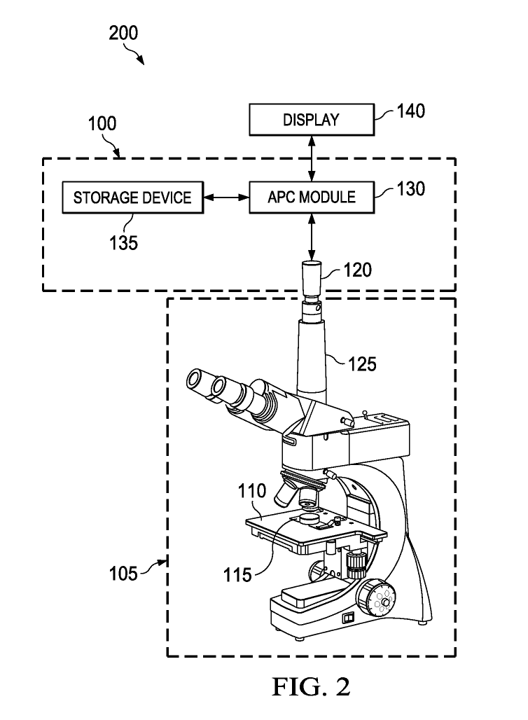

The digital microscope 30 is contained in a housing and has integrated capabilities of image acquisition, image processing, and network communications (APC). The housing can be composed of, for example plastic, metal and/or rubber. The housing can be nearly seamless when parts integrated by a single manufacturer, or provide connections interfaces to screw or plug in additional hardware. In some implementations, the digital microscope 30 includes an integrated still or video camera. In other implementations, the digital microscope 30 includes a integrated networking capabilities for a tetherless or a tethered connection to the network 199. A more detailed description of the digital microscope 30 is set forth below in association with FIGS. 2 to 4.

The medical records database 10 can be a single computing device similar to computing devices 10, 20 that includes database software for storing medical records as relational database. In another embodiment, the medical records database 40 can be a network of storage devices operating as a storage network over a distributed platform. The medical records database 10 includes a network interface (not shown). The network interface controls data exchange with the network 199. Additionally, the database software interfaces with software of the computing devices 10, 20 to provide access to medical records stored therein. The records can be created, modified, deleted, searched and aggregated.

In operation, the doctor sends samples from a patient to a telepathology center that uses a digital microscope 30. For example, the doctor can draw blood with a needle, take a biopsy of an organ or surface skin, and collect a urine sample or the like. The doctor can also log on to the medical records database 10 to provide specific instructions related to the sample or provide further information about patient symptoms.

Slides of the sample are prepared and placed on the digital microscope 30 for enhanced viewing. A pathologist, located remotely from the digital microscope 30, views slides from the computing device 10. The digital microscope 30 can provide a view of a portion of the slide under review. The pathologist navigates the digital microscope 30 remotely to view different portions of the slide. To do so, the computing device 20 interfaced with the digital microscope 30 sends control commands over the network. After review, the pathologist stores reports and findings on the medical records database 40. Subsequently, the initiating doctor can use computing device 10 or any other suitable device to obtain the pathology report and findings and to review slide images or video.

FIG. 2 is a schematic illustrating a digital microscope 200 with an integrated image APC module 130 according to one embodiment. The digital microscope 200 includes a microscope component 105, a digital component 100, and display 140 for local viewing by staff. The microscope component 105 and the digital component 100 can be contained within a single housing. A physical port can optionally be included to connect a network cord.

The microscope component 105 can be, for example, a trinocular microscope or robotic microscope that includes a stage 110. A slide 115 is placed over the stage 110 and can include an oral sample, a blood sample, a hair sample, or the like. The stage 110 supports the slide for viewing. The stage 110 can be positioned using an x-axis for horizontal movement, a y-axis for vertical movement, and a z-axis to move closer to lens. In various embodiments, the microscope component can be equipped with one or more of two 10× wide field eye pieces, 1 nos. objectives (parafocal achromatic 0.1 NA), 10× (parafocal achromatic 0.25 NA), 40×SL (parafocal achromatic 0.65 NA) or 100×SL oil immersion (parafocal achromatic 1.25 NA). The microscope component 105 can include phase attachments. The stage 110 can have a horizontal mechanical size of, for example, 120 mm×125 mm minimum. Illumination can be provided by a high intensity compact light source, such as a 6V, 20 W Halogen lamp with an on/off switch, a light intensity regulator and a Plano concave mirror attachment suitable for 220V, 50 Hz AC power supply.

The digital component 100 the APC module 130 and a storage device 135. The APC module 130 performs image acquisition, image processing and network communications. In one embodiment, the APC module 130 is integrated on a single processor packaging with pins for inputting and outputting data signal. In another embodiment, the APC module 130 integrated on a single semiconductor substrate manufactured using a single mask. The substrate can be composed of silicon oxide. The storage device 135 can be a flash device or other type of memory to buffer images or video received from a camera or being streamed over a network.

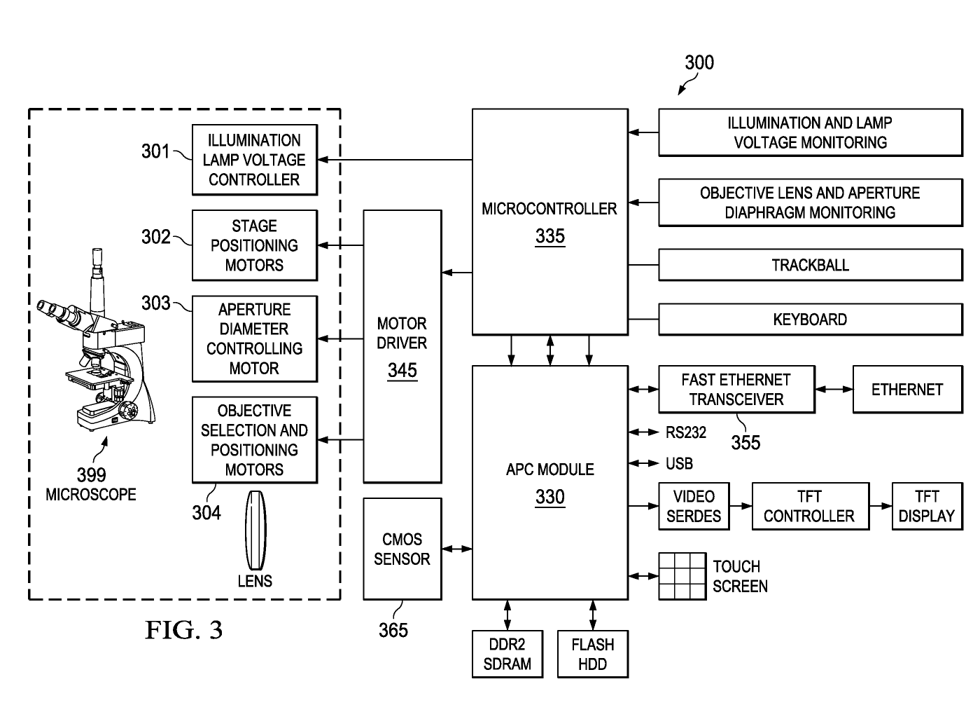

FIG. 3 is a schematic illustrating an alternative embodiment of a digital microscope 300 with an integrated APC module 330 according to another embodiment. The APC module 330 is coupled to microcontroller 335 which, in turn, is coupled to a motor driver 345 that controls an illumination lamp voltage controller 301, stage positioning motors 302, aperture diameter controlling motor 303 and an objective selection and positioning motors 304. Commands received from a network to the fast Ethernet transceiver 355 extracted from network packets by the APC module 330 and issued to the motor driver 345. In one embodiment, the motor driver 345 can scan an entire slide on a stage at different coordinates to provide an image of the entire image. Several images at the different coordinates, stitched together, represent the entire slide.

In one embodiment, the motor driver 345 provides synchronous telepathy in cooperation with the APC module 330. In particular, a pathologist can remotely control the digital microscope. The control commands are extracted by the APC module 330 and forwarded to the motor driver 345. The motor driver 345 includes, for example, a selector to send a signal to a mechanical component that can implement the control commands. For a control command increasing environmental illumination, a command is send to illumination lamp voltage controller 301 which controls voltage level of a lamp element. The additional light is captured by images sent back across a network to the pathologist who now has a better view of a subject.

The microcontroller 335 can be any type of processor such as a CPU, a mobile processor, or an ASIC. The microcontroller 335 executes instructions directed to other parts of the digital microscope 300 not controlled by the APC module 330 such as making mechanical adjustments responsive to digital information such as control commands.

A complementary metal oxide semiconductor (CMOS) sensor 365 is coupled to a lens on the microscope to acquire images from the stage. In operation, an analog signal is converted to a digital representation of an image. Image resolution and other characteristics of the CMOS sensor 365 are design specific. In other implementations, alternative sensors can be used to acquire images.

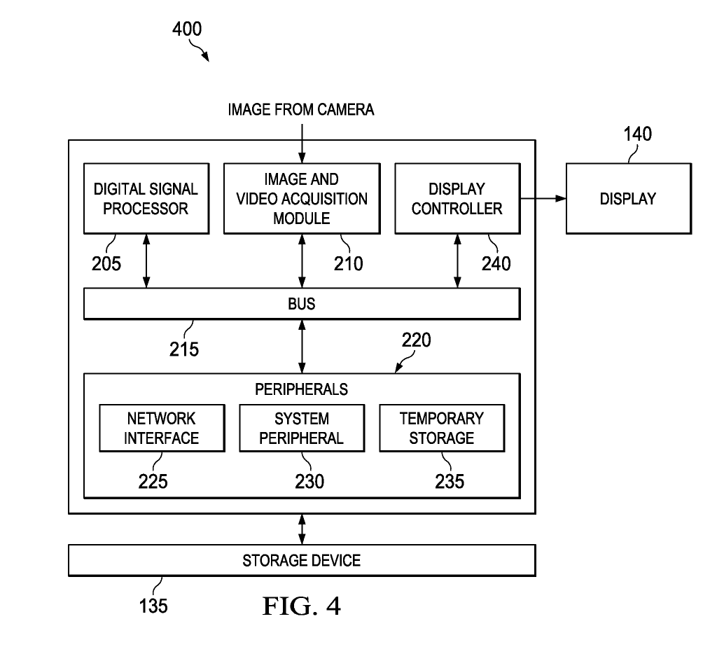

FIG. 4 is a schematic diagram illustrating details of an APC module 400 according to one embodiment. An image and video (i.e., a sequence of images) acquisition module 210 receives digital data representing an image from a slide on a stage. An exemplary image acquired can be 1.3 megapixels with full color. The image can be sent as a raw file without compression. Alternatively, the image can be compressed according to lossy or lossless image compression standards such as BMP or bitmap, JPEG or joint photographic experts group, GIF or graphic interchange format, or TIFF or tag image file format. Furthermore, the video can be sent as a raw file or compressed according to lossy or lossless video standards such as MPG3 or motion picture experts group version 3, MPG4 or motion picture experts group version 4, WMV or Windows media video, Flash video, or the like. The images can be temporarily stored or buffered in the APC module 400.

The digital signal processor 205 provides enhancements to the image to assist in telepathology or other applications. In one embodiment, image can be classified by comparing a reference image (e.g., of subject in a normal condition) to the digital image. More specifically, in another embodiment, an abnormality marked image is generated. The digital signal processor 205 can perform enhancements such as converting an image from color to grayscale, filtering the image to reduce noise, identifying boundaries, pattern matching, and other application-specific functions.

A network interface 225 can packetize outgoing data (e.g., image or video data) and de-packetize incoming data (e.g., control commands). A transceiver can be included for channel communication. One embodiment includes a physical port for a wired Ethernet connection. Other peripherals include a system peripheral 230 (e.g., a timer) and a temporary storage (e.g., DRAM or any other type of non-volatile storage).

Furthermore, APC module 400 can be implemented in hardware, software, or a combination. A bus 215 couples components of the APC module 400. Additional components can also be included such as a display controller 240.

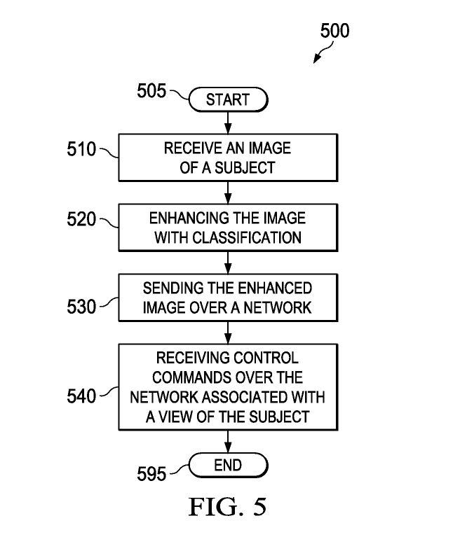

FIG. 5 is a flow diagram illustrating a method 500 for image acquisition, image processing and network communication according to an embodiment. The method 500 can be implemented in the system described above.

An image of a subject is received 510 by an APC module from a camera. The image can be stored temporarily until further processing. A single image or a video of streaming images can be provided by the camera.

During processing, the image is enhanced using various techniques by an image processing unit with a DSP module. In one example from U.S. application Ser. No. 12/605,400, the image is enhanced with classifiers 520 suitable for a particular application such as telepathology. The classifiers can detect pre-malignant and non-malignant samples. In another example, abnormalities are marked. To do so, the image may be converted from color to a gray-scale image. A noise filter can be applied to de-noise the gray-scale image. A binary image can be generated from the gray-scale image. Boundaries of an epithelial region are generated from the binary image. Next, abnormalities are identified to determine, for example, if a cell region is pre-malignant or non-malignant.

For other implementations, other types of image enhancements can be performed. For example, image recognition can be applied to an image to identify certain types of cells present in the sample.

The enhanced image is sent over a network 530. Prior to doing so, the enhanced image can be compressed as described above. In one embodiment, the compression can be manually configured, or automatically configured in accordance with characteristics of the channel. For example, network conditions such as network speed, network congestion and type of connection can be evaluated. In one embodiment, streaming video is sent over the network. Image data associated with the enhanced image is broken up into segments. The segments are included in a data portion of network packets along with data headers related to source and destination address and other characteristics of a network protocol. The network packets are further placed on a communication channel using, for example, a transceiver to convert the digital data to an analog signal at a frequency that is appropriate for the physical layer communication protocol.

Further, control commands are received over the network 540. The control commands are associated with a view or the subject. For example, z-positioning or magnification can be adjusted, as well as illumination, stage position, aperture and diameter. A pathologist remotely viewing video of a slide on a display device can make adjustments using a mouse, keyboard or other input device. Mouse pointer actions can be sent to a windowing device that sends the actions to a client application. The client application translates the mouse actions to control commands in a predetermined format that is understood by an APC module. The control commands are then packetized for transmission across a channel. When the control commands are received and depacketized, they are translated to physical or virtual adjustments of a digital microscope.

Embodiments of the invention are related to the use of a digital microscope for implementing the techniques described herein. In an embodiment of the invention, those techniques are performed by a digital microscope in response to processor executing one or more sequences of one or more instructions included in main memory. Such instructions may be read into main memory from another machine-readable medium product, such as storage device. Execution of the sequences of instructions included in main memory causes processor to perform the method embodiment of the invention described herein. In alternative embodiments, hard-wired circuitry may be used in place of or in combination with software instructions to implement the invention. Thus, embodiments of the invention are not limited to any specific combination of hardware circuitry and software.

The term “machine-readable medium product” as used herein refers to any medium that participates in providing data that causes a machine to operation in a specific fashion. Examples of the machine-readable medium product include but are not limited to memory devices, tapes, disks, cassettes, integrated circuits, servers, online software, download links, installation links, and online links.

The components, modules and units discussed herein can be implemented in software, hardware, or a combination of both.

The foregoing description sets forth numerous specific details to convey a thorough understanding of embodiments of the invention. However, it will be apparent to one skilled in the art that embodiments of the invention may be practiced without these specific details. Some well-known features are not described in detail in order to avoid obscuring the invention. Other variations and embodiments are possible in light of above teachings, and it is thus intended that the scope of invention not be limited by this Detailed Description, but only by the following Claims.

What is claimed is:

1. A digital microscope device, comprising:
a housing containing a processing unit, the processing unit further comprising:
an image capture unit, coupled to an image sensor with a view to a subject on a slide, the image capture unit receiving an image of the subject;
an image processing unit, coupled to the image capture unit, the image processing unit enhancing the image with classifications; and
a network interface, coupled to the image processing unit and to a network, the network interface sending the enhanced image across to the network and to receive control commands, the control commands associated with the view of the subject.

2. The device of claim 1, wherein the image processing unit comprises a digital signal processing unit.

3. The device of claim 1, wherein the image processing unit generates an abnormality marked image by comparing the subject on the image to a reference subject on a reference image.

4. The device of claim 1, wherein the housing further comprises:
a motor driver, communicatively coupled to the network interface to provide synchronous telepathology in cooperation with the network interface, wherein the control commands received by the network interface are directed to at least one of illumination, stage positioning, aperture diameter and z-positioning.

5. The device of claim 1, wherein the image capture unit receives video of the subject including the image as part of a sequence of images, wherein the image processing unit enhances the video, and wherein the network interface sends the enhanced video across the network.

6. The device of claim 1, wherein the image capture unit generates a virtual slide by scanning the slide as a whole at a certain magnification to receive a plurality of images at different coordinates of the slide.

7. The device of claim 1, wherein the image capture unit, the image processing unit and the network interfaces are embedded on a single processor.

8. The device of claim 1, wherein the image capture unit, the image processing unit and the network interfaces are embedded in a processor on a single substrate.

9. The device of claim 1, wherein the network interface comprises a network card with a physical port.

10. The device of claim 1, wherein the housing further comprises:
the image sensor; and
a microscopic lens coupled to the image sensor.

11. A method within performed in a digital microscope device, comprising a housing having an image capture unit, an image processing unit, and a network interface, the method comprising:
receiving an image of a subject;
enhancing the image with classifications;
sending the enhanced image across to the network; and
receiving control commands from the network, the control commands associated with the view of the subject.

12. The method of claim 10, wherein the image processing unit comprises a digital signal processing unit.

13. The method of claim 10, wherein the enhancing the image comprises generating an abnormality marked image by comparing the subject on the image to a reference subject on a reference image.

14. The method of claim 10, further comprising:
providing synchronous telepathology in cooperation with the network interface, wherein the control commands received are directed to at least one of illumination, stage positioning, aperture diameter and z-positioning.

15. The method of claim 10, wherein receiving the image comprises receiving a video of the subject including the image as part of a sequence of images, wherein enhancing the image comprises enhancing the video, and wherein sending the enhanced image comprises sending the enhanced video across the network.

16. The method of claim 10, further comprising:
scanning the slide as a whole at a certain magnification to receive a plurality of images at different coordinates of the slide.

17. The method of claim 10, wherein the image capture unit, the image processing unit and the network interfaces are embedded on a single processor.

18. The method of claim 10, wherein the image capture unit, the image processing unit and the network interfaces are embedded in a processor on a single substrate.

19. The method of claim 10, wherein the network interface comprises a network card with a physical port.

20. The method of claim 10, wherein the housing further comprises:
the image sensor; and
a microscopic lens coupled to the image sensor.

21. A processing unit, comprising:
an image capture unit, coupled to an image sensor with a view to a subject on a slide, the image capture unit receiving an image of the subject;
an image processing unit, coupled to the image capture unit, the image processing unit enhancing the image with classifications; and
a network interface, coupled to the image processing unit and to a network, the network interface sending the enhanced image across to the network and to receive control commands, the control commands associated with the view of the subject,
wherein the image capture unit, the image processing unit and the network interface are embedded on a common semiconductor substrate.
